(19) United States
(12) Patent Application Publication
(10) Pub. No.: US 2006/0274723 A1
(43) Pub. Date: Dec. 7, 2006

(54) Method and system for customer-managed call routing

(75) Inventors: Faisal Siyavudeen, Trichur (IN); Prasanna Venkatraman, Senthil Nagar (IN)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/143,375

(22) Filed: Jun. 1, 2005

(51) Int. Cl. H04L 12/66; H04L 12/56

(52) U.S. Cl. 370/352; 370/401

(57) ABSTRACT

A method, system and apparatus are provided for call routing in a telephony network. The telephony network includes at least one voice gateway and is associated with a plurality of Virtual Private Networks (VPNs). The telephony network provider provides conventional telephony network access to all its VPN customers, while providing VPN customers with the freedom to manage call routing/processing in their networks. This is done by co-locating the voice gateway with the Provider Edge (PE) router of the provider network and registering the voice gateway with the routing entity in each VPN.

### BACKGROUND OF THE INVENTION

1. Field of Invention

Embodiments of the invention relate in general to a telephony network. More specifically, the embodiments of the invention relate to methods and systems for customer-managed call routing in a telephony network.

2. Description of the Background Art

Large telephony networks are generally run by a single service provider. With a single provider network having a large number of Customer Premises Equipment (CPE), communication between the various CPE may not be secure. Further, there is a huge amount of traffic in the provider network. This makes the telephony network difficult to manage. In addition, the provider network includes many CPE that belong to a single customer, and each customer wants the calls made between its CPE to be secure.

There are several conventional methods for providing secure private networks that run on top of a single provider network. The provider network has a mechanism for segregating calls, based on various parameters for segregation decided for each private network. This segregation renders the data being exchanged within a particular private network inaccessible to any other private network.

One such mechanism for providing private networks running on top of a single provider network is enabled by using Virtual Private Networks (VPNs). Each VPN is connected to a device at the edge of the provider network, known as a Provider Edge (PE) router. Each PE router interfaces with the provider network as well as each VPN. VPN Routing and Forwarding (VRF) labels enable IP packets destined to private networks to propagate across the provider network. The PE router has IP addresses that belong to each VPN it supports. A separate routing table is maintained at the PE router for each VPN, so that call traffic is segregated and only sent over the correct private network.

Further, a customer running a private network, wanting to have Public Switched Telephone Network (PSTN) access, typically runs a Private Branch Exchange (PBX) for PSTN connectivity and connects to the PBX, using a voice gateway within the VPN. This voice gateway originates Voice over Internet Protocol (VoIP) traffic, which is routed through the PE router to a remote site in the VPN.

Another mechanism for providing private networks running on top of a single provider network is enabled by providing VoIP call routing in a VRF environment, where the provider network manages the call-routing function. However, this mechanism cannot be deployed in scenarios where communication is required between a provider-managed H.323 gatekeeper or a Session Initiation Protocol (SIP) proxy, and a customer-managed IP CPE within a VPN, since the gatekeeper RAS (Registration, Admission, Status) address or a SIP proxy's address within the provider network is not accessible from the VPN RAS address on the VoIP CPE.

Further, every customer running a VPN needs to have its own voice gateway for call routing, making the system expensive and difficult to maintain. In addition, each customer may wish to take decisions on numbering plans, bandwidth policies, and call authorization for its VPN. These decisions are currently made by the public provider for all VPNs associated with it.

### BRIEF DESCRIPTION OF THE DRAWINGS

FIG. 1 illustrates a representative network, in accordance with an exemplary embodiment of the present invention.

FIG. 2 illustrates the connection between a PE router, a voice gateway, VRF labels, and VPNs, in accordance with an exemplary embodiment of the invention.

FIG. 3 illustrates the various components of a voice gateway, in accordance with an exemplary embodiment of the invention.

FIG. 4 illustrates the various components of a gatekeeper, in accordance with an exemplary embodiment of the invention.

FIG. 5 is a flowchart depicting a method for call routing in a telephony network, in accordance with an exemplary embodiment of the invention.

FIG. 6 is a flowchart that depicts a method for call routing from a Plain Old Telephone System (POTS) phone to a VoIP phone, in accordance with an exemplary embodiment of the invention.

FIG. 7 is a flowchart that depicts a method for call routing from a VoIP phone to a POTS phone, in accordance with an exemplary embodiment of the invention.

### DETAILED DESCRIPTION OF EMBODIMENTS OF THE INVENTION

Embodiments of the invention provide a method, a system, an apparatus and a machine-readable medium for call routing in a telephony network. In an embodiment of the invention, a service provider manages the telephony network. In an embodiment of the invention, the network can be a Multiple Protocol Label Switching (MPLS) network. Further, the network may be associated with a plurality of private networks such as Virtual Private Networks (VPNs), which are run by the service provider, and the customers of the service provider use the VPNs to run their services. In an embodiment of the invention, the private networks may be kept isolated from each other. The private networks may also include virtual Local Area Networks (VLAN), wherein the private networks are segregated based on OSI layer 2 addresses. In an embodiment of the invention, the service provider allows VPN customers to manage Voice-over-Internet Protocol (VoIP) call routing within their respective VPNs, with the help of a voice gateway within the provider network and a gatekeeper within the VPNs. VoIP signaling can be performed by using protocols such as H.323, Session Initiation Protocol (SIP), and Media Gateway Control Protocol (MGCP). The service provider also allows the VPN customers to manage call-numbering plans, make bandwidth policies, and control call authorization. Each private network performs these functions with the help of a gatekeeper associated with it.

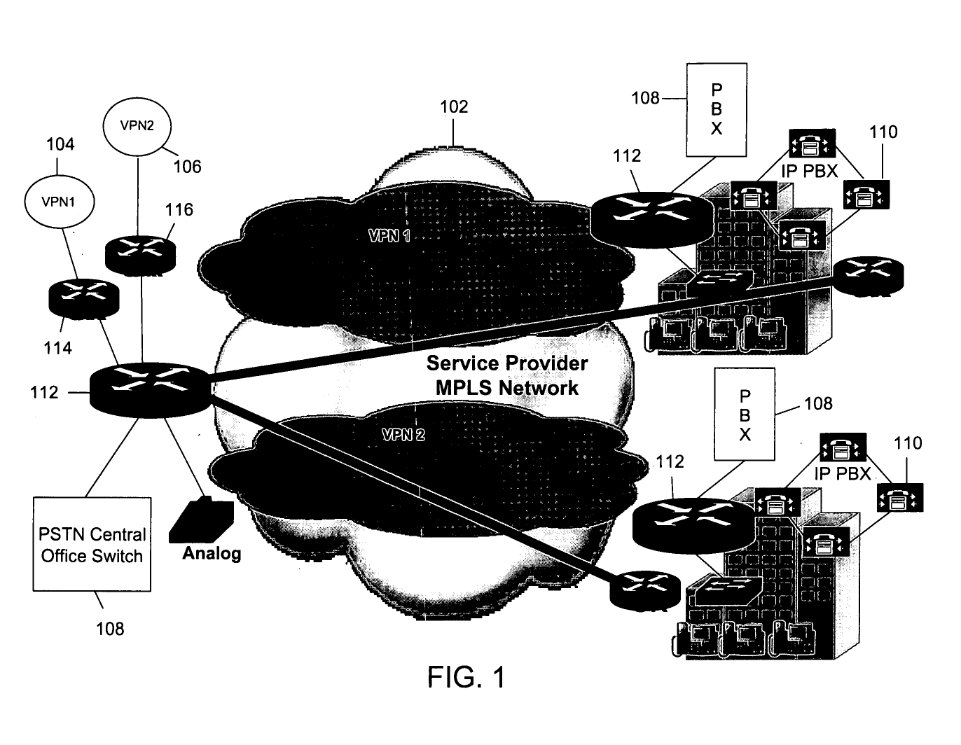

FIG. 1 illustrates a representative network 100, in accordance with an exemplary embodiment of the present invention. Network 100 includes an MPLS network 102, VPNs 104 and 106, Private Branch Exchanges (PBXs) 108, IP PBXs 110, Provider Edge (PE) routers 112, and gatekeepers 114 and 116.

MPLS network 102 is a telephony network run by a public service provider. VPNs 104 and 106 are associated with MPLS network 102. VPNs are used to enable secure private networks that run on a public provider network. MPLS network 102 may also be associated with VLANs, wherein there is no IP connectivity between the individual VLANs.

In one embodiment of the invention, MPLS network 102 are further associated with PBXs 108. PBXs 108 are in-house telephone switching systems that interconnect telephone extensions to each other as well as to the outside PSTN. A PBX enables a single-line Customer Premise Equipment (CPE) to gain access to a desired trunk selected from a group of pooled (shared) trunks. PBXs also include functions such as least cost routing for outside calls, call forwarding, conference calling, and call accounting. In various embodiments of the invention, the PBXs are connected to the VPN network through the voice gateway, and are used to manage the conventional telephone systems of the customer using the VPN. In an embodiment of the invention, PBXs 108 can be PSTN central office switches used for connectivity with the PSTN.

In an embodiment of the invention, MPLS network 102 is also associated with IP PBXs 110. IP PBXs 110 are PBXs that support the IP protocol along with the traditional analog and digital circuit-switched (TDM) connections to the MPLS and the CPE. IP PBXs are present within the VPN, wherein the different parts of the VPN are connected using a shared MPLS network run by the provider, and are used to manage the CPE within the VPNs.

MPLS network 102 further includes PE router 112. In an embodiment of the invention, PE router 112 provides an interface between MPLS network 102 and VPNs 104 and 106. Further, it can also provide an interface between MPLS network 102, PBXs 108, and IP PBXs 110. PE router 112 includes a voice gateway. In an embodiment of the invention, PE router 112 is a voice gateway.

In an embodiment of the invention, MPLS network 102 is also associated with gatekeepers 114 and 116, which are network devices within corresponding VPNs 104 and 106. Each gatekeeper possesses a unique IP address that corresponds to the VPN it is in. Each gatekeeper receives call admission requests from CPE in its VPN. The CPE may be a voice gateway or an IP PBX.

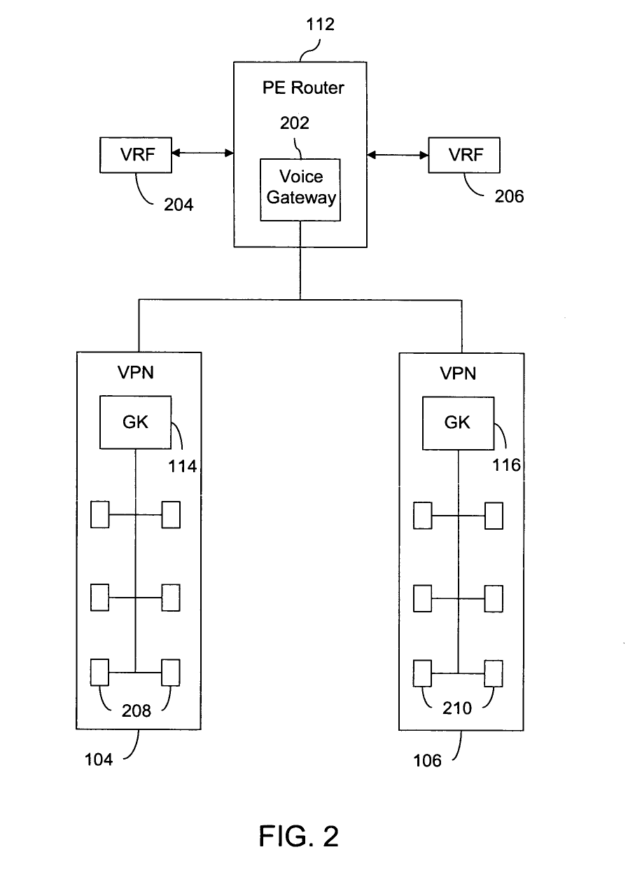

FIG. 2 depicts the connection between PE router 112, a voice gateway 202, VPN Routing and Fowarding (VRF) labels 204 and 206, and VPNs 104 and 106, in accordance with an exemplary embodiment of the invention. FIG. 2 also depicts the architecture of VPNs 104 and 106, which include gatekeepers 114 and 116, and CPE 208 and 210, respectively.

Each gatekeeper receives call admission requests from CPE in its corresponding VPN. For example, gatekeeper 114 receives call admission requests from CPE 208, associated with VPN 104.

Each call made by a CPE in a VPN is directed to PE router 112, via the gatekeeper of the VPN. PE router 112 sends the call to the voice gateway co-located with it. The voice gateway identifies the IP address to which the call has been made, and redirects the call to the gatekeeper of the VPN identified by this IP address. This identification is carried out with the help of a VRF label corresponding to the VPN. If the call is made to the PSTN network, the voice gateway initiates a call setup using the appropriate PSTN signaling protocol. The gatekeeper possesses aliases of each CPE in the VPN. When a call admission request is directed from the voice gateway to the gatekeeper, the gatekeeper searches through its database of aliases and identifies the CPE to which the call has been addressed. The gatekeeper then directs the call to the identified CPE.

CPE include, but not limited to, terminating equipment such as terminals, telephones, and modems installed at customer sites, and connected to the telephony network.

Voice gateway 202 is associated with PE router 112. A voice gateway is also known as a VoIP gateway. Voice gateway 202 originates VoIP traffic that passes through PE router 112 to CPE 208 and 210 in respective VPNs 104 and 106. A single VoIP gateway runs on a PE router and terminates conventional telephony traffic in the corresponding VPN.

Each VRF label corresponds to a particular VPN and includes the routing information that defines that particular VPN. For example, VRF label 204 contains the IP address for VPN 104. VRF label 204 enables the propagation of this IP address across MPLS network 102.

For example, PE router 112 gets a call. The destination of the call is CPE 208. PE router 112 directs the call to voice gateway 202. Voice gateway 202 identifies the gatekeeper 114 in VPN 104 with the help of VRF label 204 and sends a call admission request to gatekeeper 114. Gatekeeper 114 searches through its database of aliases, identifies the address of CPE 208, and directs the call to CPE 208.

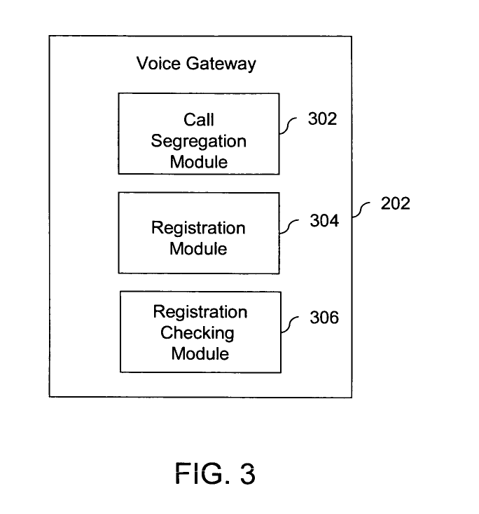

FIG. 3 represents voice gateway 202 and its components, in accordance with an exemplary embodiment of the invention. Voice gateway 202 includes a call segregation module 302, a registration module 304, and a registration checking module 306. In various embodiments of the invention, the system elements of voice gateway 202 can be implemented in the form of software, hardware, firmware, and their combination thereof.

Call segregation module 302 identifies the VPN to which a call is to be directed. This segregation is carried out by tying incoming voice interfaces (or groups of voice interfaces such as trunk groups) to corresponding VRF labels. Other methods of segregating calls may be by the use of dial-peer-level configurations, which segregate calls based on call parameters such as the called/calling number, incoming voice interface, and trunk groups. In an embodiment, this method is applied to public provider networks where the numbering plan is global. These segregation methods may be customized according to control mechanisms on the gateway, such as call control scripting.

Registration module 304 registers the voice gateway to each call routing entity (gatekeeper) of a VPN. In various embodiments of the invention, the registration is performed by means of H.323 registration procedures. Separate registrations are maintained for each gatekeeper. Therefore, each gatekeeper has its own view of the gateway and assumes that all CPE registered with it belongs to the VPN it is associated with. CPE 208, which runs inside VPN 104, is registered to gatekeeper 114 and is able to communicate with voice gateway 202. This is just as though voice gateway 202 were run by the customer that owns VPN 104. Further, each CPE may be registered on a single VPN or multiple VPNs, depending on the routing plan of calls. Each voice gateway acts as multiple logical gateways for the H.225.0 RAS (Registration, Admission, Status) functionality. The call signaling and media traffic carries in its source address field, the same call signaling and media addresses that are registered to the gatekeeper that corresponds to the VPN.

In an exemplary embodiment of the invention, the call routing identity is a registrar, when the call control software package being used is a Session Initiation Protocol (SIP) Proxy server.

Registration-checking module 306 checks whether voice gateway 202 is registered with each gatekeeper. If registration-checking module 306 finds a gatekeeper that voice gateway 202 is not registered with, it contacts registration module 304 to register voice gateway 202 with the gatekeeper. As described earlier, the gatekeeper identification is performed with the help of a corresponding VRF label.

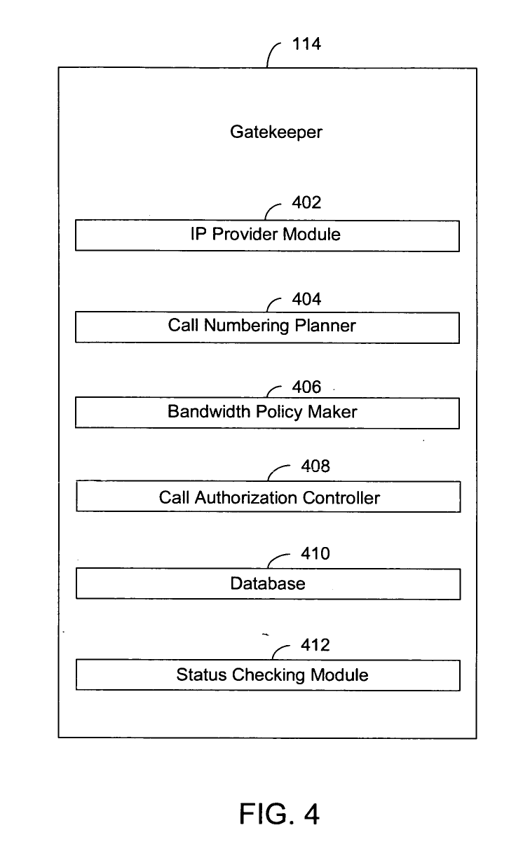

FIG. 4 represents gatekeeper 114 and its components, in accordance with an exemplary embodiment of the invention. Gatekeeper 114 includes an IP provider module 402, a call numbering planner 404, a bandwidth policy maker 406, a call authorization controller 408, a database 410, and a status-checking module 412. In various embodiments of the invention, the system elements of gatekeeper 114 can be implemented in the form of software, hardware, firmware, and their combination thereof.

When a call is initiated in CPE 208, it is routed to gatekeeper 114. IP provider module 402 provides the IP address of voice gateway 202, to which the call initiated at CPE 208 is to be routed.

Call numbering planner 404 decides the numbering plan to be followed to number CPE 208 in VPN 104. Bandwidth policy maker 406 makes the policies that govern the bandwidth of the calls being made by CPE 208 in VPN 104. Call authorization controller 408 decides on various parameters to control the authorization criteria decided on calls entering and leaving VPN 104. Gatekeeper 114 maintains database 410, which contains the aliases of all CPE 208 in VPN 104. Some examples of aliases are numbers, IP addresses and Universal Resource Locators (URLs).

Status-checking module 412 takes an update of the status of each CPE 208 in VPN 104. For example, the status of a CPE 208 may be busy or not working.

By having a gatekeeper inside each VPN, the customer running the VPN is able to control call routing and processing. Further, the customer can maintain its own numbering plans, bandwidth policies, and control call authorization. The customer can do all this without liaisoning with the service provider. An exemplary scenario is where the customer is running IP PBX-based VoIP networks within the VPN and wants to outsource PSTN access to the service provider.

In an embodiment of the invention, the communication between each gatekeeper and the CPE connected to it is compliant with H.323 standards. Further, the communication between each voice gateway and the gatekeepers connected to it can also be compliant with H.323 standards. In various embodiments of the invention, there is no non-standard messaging involved. These communication standards enable communication between any gatekeeper and CPE-compliant H.323 standards that run within customer VPNs.

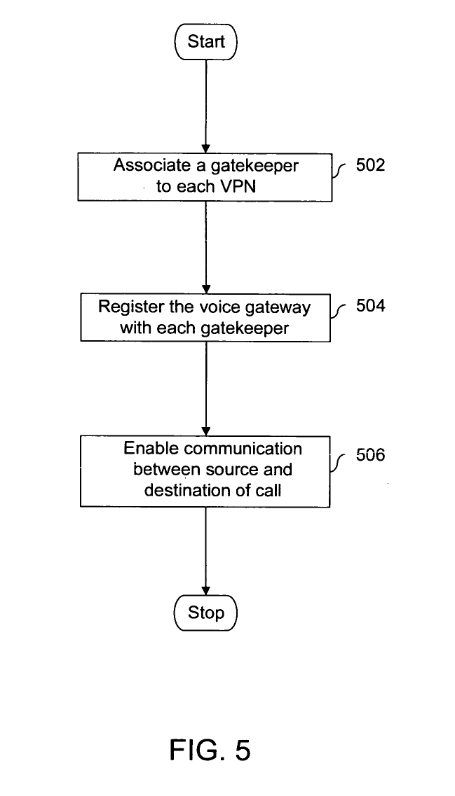

FIG. 5 is a flowchart that depicts a method for call routing in a telephony network, in accordance with an exemplary embodiment of the invention.

At step 502, each VPN in the telephony network is associated with a gatekeeper. For example, VPNs 104 and 106 are provided with gatekeepers 114 and 116. At step 504, the voice gateway is registered with each gatekeeper it is connected to. For example, voice gateway 202 is registered with gatekeepers 114 and 116 of VPNs 104 and 106, using registration module 304. At step 506, communication is enabled between the source of a call and its destination. This call is routed through the gatekeepers and the PE routers in the telephony network. For example, if the source of the call is CPE 208, and the destination of the call is CPE 210, the call is routed through gatekeeper 114, PE router 112, and gatekeeper 116.

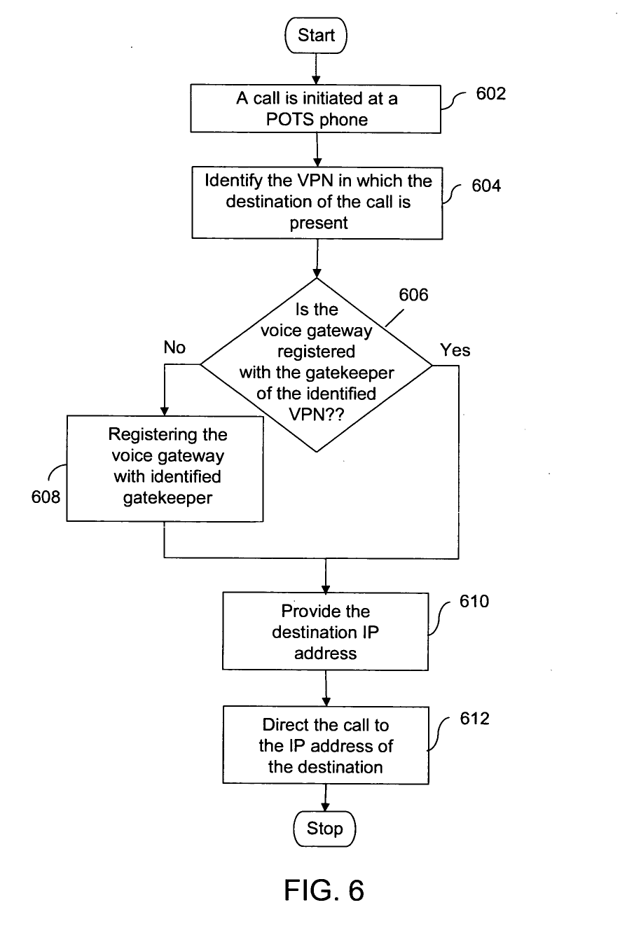

FIG. 6 depicts a flowchart that describes a method for call routing in a telephony network, wherein the source of the call is a Plain Old Telephone System (POTS) phone, and the destination of the call is a VoIP phone, in accordance with another exemplary embodiment of the invention.

At step 602, a call is initiated at a POTS phone in the telephone network. At step 604, the VPN in which the destination of the call is present, is identified. In various embodiments of the invention, this involves identifying the IP address of the destination of the call. At step 606, it is checked whether the voice gateway is registered with the gatekeeper of the identified VPN. If it is not registered, then step 608 is performed. At step 608, the voice gateway is registered with the identified VPN. The call is then directed to the gatekeeper of the identified VPN by means of H.323 admission procedures. At step 610, the destination IP address is provided by the gatekeeper. The gatekeeper then directs the call to the provided IP address at step 612.

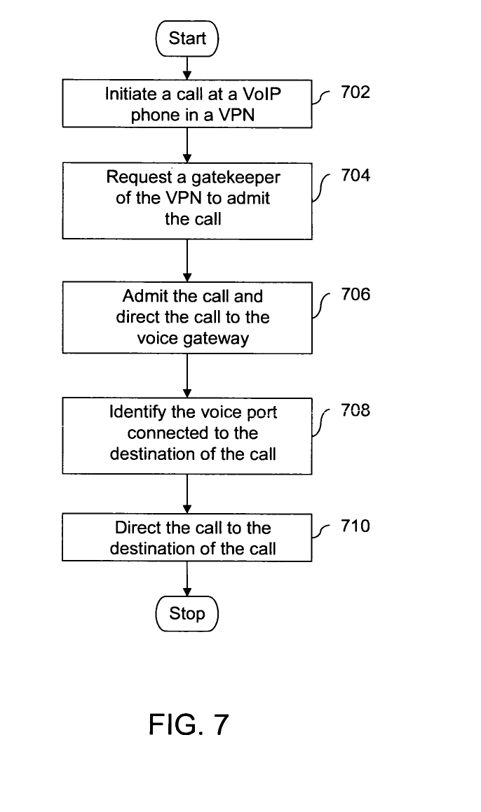

FIG. 7 depicts a flowchart that describes a method for call routing in a telephony network, wherein the source of the call is a VoIP phone, and the destination of the call is a POTS phone, in accordance with another exemplary embodiment of the invention.

At step 702, a call is initiated at a VoIP phone in a VPN in the telephony network. At step 704, a call admission request is sent to the gatekeeper of the VPN. At step 706, the gatekeeper admits the call and directs it to the voice gateway. At step 708, the voice gateway identifies the voice port connected to the destination of the call. At step 710, the call is transferred to the destination of the call via the voice port.

In an exemplary embodiment of the invention, when a call is made from a VoIP phone to a POTS phone, it is initiated from a CPE in a VPN, according to H.323 standards. The call is sent to the gatekeeper of the VPN, by means of H.323 admission procedures. The gatekeeper of the VPN directs the call to the voice gateway in the PSTN network.

Embodiments of the present invention have the advantage that a single voice gateway, co-located with the provider network and registered with the routing entity within each VPN, is sufficient for routing calls to VPNs in the provider network. Therefore, each VPN does not need to be provided with its own voice gateway. Further, each private network provider is capable of deciding call routing policies and plans, such as call-numbering plans, bandwidth polices, and call authorization policies for its own VPN, without the interference of the public service provider. Therefore, each public service provider can provide conventional telephony network access to all its VPN customers, while providing them with the freedom to manage call routing/processing within their networks.

Although the invention has been discussed with respect to specific embodiments thereof, these embodiments are merely illustrative, and not restrictive, of the invention. For example, a ‘method for call routing in a telephony network’ can include any type of analysis, manual or automatic, to anticipate the needs of the method.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for call routing in a telephony network, the telephony network comprising at least one voice gateway, one or more Virtual Private Networks (VPNs) associated with each voice gateway, the method comprising
associating a gatekeeper to each VPN;
registering the voice gateway with each gatekeeper; and
enabling communication between the source of a call and the destination of the call via a gatekeeper associated with the destination of the call.

2. The method of claim 1 wherein the enabling communication comprises
initiating a call from the source of the call, the source of the call being a CPE in a VPN;
requesting a gatekeeper present in the VPN to admit the call;
admitting the call, wherein the gatekeeper admits the call;
transferring the call to the voice gateway, the call being transferred by the gatekeeper;
identifying a second gatekeeper of the VPN in which the destination of the call is located, the identification being done by the voice gateway;
directing the call to the identified second gatekeeper; and
directing the call to the destination of the call, wherein the directing is performed by the second gatekeeper.

3. The method of claim 2 wherein the identifying a second gatekeeper further comprises
checking whether the voice gateway is registered with the second gatekeeper;
if the voice gateway is not registered
registering the voice gateway with the second gatekeeper.

4. The method of claim 2 wherein the communication enabled by each gatekeeper is based on at least one of numbering plans, bandwidth policies, and control call authorizations to the VPN.

5. The method of claim 2 wherein the voice gateway is a Voice over Internet Protocol (VoIP) gateway.

6. The method of claim 2 wherein the communication between the voice gateway and each gatekeeper is according to H.323 standards.

7. The method of claim 2 wherein the communication between each gatekeeper and the source/destination of the call is according to H.323 standards.

8. The method of claim 2 wherein the identification of the gatekeeper to which the call is to be directed is performed by providing a VPN routing/forwarding (VRF) label to each call.

9. The method of claim 8 wherein the registration of the voice gateway to each gatekeeper is performed by mapping each VRF label to a corresponding gatekeeper.

10. The method of claim 2 wherein the identification of a gatekeeper to which the call is to be directed is based on call parameters, the call parameters being at least one of a called number, a calling number, incoming voice interface, and trunk groups.

11. A system for call routing in a telephony network, the telephony network comprising at least one voice gateway, one or more VPNs associated with each voice gateway, the system comprising
a call receiver, for receiving a call from the source of the call;
one or more gatekeepers for directing the received call to the destination of the call, wherein each gatekeeper is associated with a corresponding VPN;
a registration checking module for checking if the voice gateway is registered with each gatekeeper;
a registration module for registering the voice gateway with each gatekeeper; and
a call segregation module for identifying the gatekeeper to which the received call is to be transferred, wherein the identified gatekeeper routes the call to the destination of the call.

12. The system of claim 11 wherein the telephony network further comprises at least one provider edge (PE) router.

13. The system of claim 11 wherein the gatekeeper comprises
an Internet Protocol (IP) provider module for providing the IP address of the voice gateway;
a database for storing aliases of phones in the VPN;
a status checking module for checking the status of each phone in the VPN;
a call numbering planner for providing call numbering plans to the VPN;
a bandwidth policy maker for making bandwidth policies for the VPN; and
a call authorization controller for controlling the call authorization in the VPN.

14. An apparatus for call routing in a telephony network, the telephony network comprising at least one voice gateway, one or more VPNs associated with each voice gateway, the apparatus comprising
a processing system including a processor coupled to a display and user input device;
a machine-readable medium including instructions executable by the processor comprising
one or more instructions for associating a gatekeeper to each VPN;
one or more instructions for registering the voice gateway with each gatekeeper; and
one or more instructions for enabling communication between the source of a call and the destination of the call via a gatekeeper associated with the destination of the call.
